(19) United States
(12) Patent Application Publication
(10) Pub. No.: US 2026/0075124 A1
(43) Pub. Date: Mar. 12, 2026

(54) SYSTEM AND METHOD FOR CONTEXT-BASED PACKET CLASSIFICATION FOR NETWORKED COMMUNICATIONS

(71) Applicant: AAA Internet Publishing Inc., West Kelowna (CA)

(72) Inventor: Robert Michael Norman Bartlett, West Kelowna (CA)

(21) Appl. No.: 19/325,286

(22) Filed: Sep. 10, 2025

Related U.S. Application Data
(60) Provisional application No. 63/693,476, filed on Sep. 11, 2024.

(51) Int. Cl. H04L 69/22; H04L 43/026; H04L 43/062

(52) U.S. Cl. CPC H04L 69/22; H04L 43/026; H04L 43/062

(57) ABSTRACT

Systems, methods, and computer-readable storage media for packet classification, and more specifically to cloud-driven traffic classification. A system can receive, at a packet identifier, a packet comprising a packet header and packet data, and generate a Universally Unique Identifier (UUID) based on the packet header. The system can then transmit the UUID from the packet identifier to a UUID cloud database and receive, at the packet identifier from the UUID cloud database, packet management instructions. The system can then provide the packet and the packet management instructions to a router.

### PRIORITY

This application claims priority to U.S. provisional patent application no. 63/693,476, filed September 11, 2024, the contents of which are incorporated herein in their entirety.

### BACKGROUND

### 1. Technical Field

The present disclosure relates to packet classification, and more specifically to cloud-driven traffic classification.

### 2. Introduction

There exist several different methods to aid with management and prioritization of traffic by network administrators. These methods can be described as Quality of Service (QoS) tagging. Some common examples of QoS tagging and/or traffic prioritization include Differentiated Services Code Point (DSCP), Wi-Fi Multimedia (WMM), Low Latency DOCSIS (LLD), and VLAN or 5G network slicing. While many of these QoS tagging systems have existed for a very long time, adoption and effective use of these systems is a challenge. A content provider or a consumer is very likely to classify all their content as high priority, clouding the context required for a network administrator to effectively manage network delivery. If everything is high priority, nothing is high priority.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a packet identifier, a packet comprising a packet header and packet data; generating, via at least one processor of the packet identifier, a Universally Unique Identifier (UUID) based on the packet header; transmitting the UUID from the packet identifier to a UUID cloud database; receiving, at the packet identifier from the UUID cloud database, packet management instructions; and providing the packet and the packet management instructions to a router.

A system configured to perform the concepts disclosed herein can include: at least one processor; and a non-transitory computer-readable storage medium having instructions stored which, when executed by the at least one processor, cause the at least one processor to perform operations comprising: receiving a packet comprising a packet header and packet data; generating a Universally Unique Identifier (UUID) based on the packet header; transmitting the UUID to a UUID cloud database; receiving, from the UUID cloud database, packet management instructions; and providing the packet and the packet management instructions to a router.

A non-transitory computer-readable storage medium configured as disclosed herein can have instructions stored which, when executed by at least one processor, cause the at least one processor to perform operations which include: receiving, at a packet identifier, a packet comprising a packet header and packet data; generating a Universally Unique Identifier (UUID) based on the packet header; transmitting the UUID to a UUID cloud database; receiving, from the UUID cloud database, packet management instructions; and providing the packet and the packet management instructions to a router.

### BRIEF DESCRIPTION OF THE DRAWINGS

FIG. 1 illustrates a first example system obtaining packet management instructions from a cloud-based database;

FIG. 2 illustrates a second example system of obtaining packet management instructions from a cloud-based database;

FIG. 3 illustrates an example of a system (acting as a firewall) blocking packets from a client to a server based on information from the cloud-based database;

FIG. 4 illustrates an example of a system (acting as a gateway) forwarding from a client to a server based on information from the cloud-based database;

FIG. 5 illustrates an example method embodiment; and

FIG. 6 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Network traffic is the amount of data moving across a computer network at any given time. Network traffic, also called data traffic, is broken down into data packets and sent over a network before being reassembled by the receiving device or computer. Network traffic has two directional flows (e.g., north-south and east-west). Traffic affects network quality because an unusually high amount of traffic can mean slow download speeds or spotty Voice over Internet Protocol (VoIP) connections. Traffic is also related to security because an unusually high amount of traffic could be the sign of an attack.

When data travels over a network or over the internet, it must first be broken down into smaller batches so that larger files can be transmitted efficiently. The network breaks down, organizes, and bundles the data into data packets so that they can be sent reliably through the network and then opened and read by another user in the network. Each packet takes the best route possible to spread network traffic evenly.

Quality of Service (QoS) systems operate to manage the network traffic as efficiently as possible, routing some data that needs immediate delivery (e.g., voice or video calls) quickly, while other data (where lag or delay won’t be noticed) slowly. There are several shortcomings with current QoS systems, leading to poor end to end adoption of QoS in network ecosystems:

1) Significant Resource Usage: QoS systems require analysis and processing of traffic on a network device. As traffic increases, this creates a strain on system resources, creating the opposite effect. Instead of optimizing traffic, the network device will slow down because traffic processing requires too many system resources. As a result, QoS services will often be turned off to conserve resources.

2) Inaccurate Prioritization: If too much traffic is prioritized, or inaccurate traffic is prioritized, the desired prioritization effect will not occur.

3) QoS Rules Are Not Up to Date: The QoS rules will be determined by a local ruleset on the network device. Network traffic can change on a monthly or even daily basis. If local rules are not updated, prioritization will fail.

4) QoS Without Context: A key issue is that someone must decide what traffic is important. If no context is provided, it is very difficult for an end user or a network provider to decide or agree on how to enforce QoS.

By contrast, systems configured as disclosed herein: 1) allow network administrators or end users to accurately identify, classify and properly manage the traffic on their network; and 2) have a small footprint on network device(s) that will have cloud driven traffic classification and QoS rules that are always up to date. Such systems can be third party context-based packet classification systems which assist network administrators or end users with traffic management, using a small footprint on network devices, driven by shared a cloud system for analysis and identification of network traffic.

To do so, the system can establish Universally Unique Identifiers (UUIDs) in an alphanumeric format for packets. These UUIDs can be created by hashing a subset of information available in packet headers. The purpose of these identifiers is to allow a cloud database (DB) lookup by network operators, thereby accessing information/metadata about the connection which is not stored within the packet itself, and allowing the network operators to further determine how such data should be managed.

The UUID cloud DB lookup process can operate as follows. When the system has a packet UUID, the system can use this UUID to securely query a cloud DB to get more information about that packet to determine how the content should be managed. Information that may be included in the cloud DB can include:

A) The source Internet Protocol (IP) address and/or the destination IP address. If the source or destination IP address that the system sees does not match a stored UUID, this could be an indication of a proxy or VPN being used, network obfuscation, and/or an attempt to hijack or spoof the data.

B) Geolocation data for the source and destination IP addresses.

C) Reputation information for the source and destination IP addresses.

D) Unique device fingerprint identifications for the source and destination devices. When possible, additional device data can be used to identify unique devices communicating on the network. This device fingerprint can be used to further enhance traffic identification, reputation and security.

E) Is the traffic coming from an authenticated device or account?

F) What kind of traffic is it? For example, the traffic may be web, gaming, video streaming, video communications, work from home, etc.

G) What is the recommended prioritization for this data?

Because this data is stored in a cloud DB (which is separate from the packet header UUID), there is virtually no limit to the amount of type of data that could be stored about the packets to help the system with traffic management. In addition, the types of data, amount of data, and quality of the data can change over time.

Because the system uses a cloud DB to lookup UUIDs, the security of the network is enhanced. For example, if there is a source/destination IP mismatch with a stored UUID, or if a UUID is not registered yet (because the packet header changed), such conditions can be identified as suspicious. In addition, while IP addresses are easy to change, device fingerprints are much more difficult to change. This makes it much easier for the system to identify both trusted and untrusted devices. Moreover, the system allows for any traffic not in the UUID cloud DB (e.g., anomalous/suspicious traffic, such as bot traffic or malware) to be de-prioritized or flagged for review and future classification.

The system, including a centralized cloud database, can share network and security information across all devices in the network. The more devices in the network, the more accurate and powerful the system can be. Instead of expecting a single network device to accurately provide QoS services, thousands or millions of devices can be used to dramatically increase the accuracy of the system. In addition, AI can be leveraged to accelerate the learning of the system and improve the accuracy of traffic classification across all networked devices.

Consider the following example. A router is configured to route traffic from one or more computer systems across a network, with the disclosed system receiving and analyzing data before forwarding the data to the router. As data is received at the system, the system identifies the header packets within the data, the header packets containing information such as: source, destination, sequence number (i.e., how much data is being sent), the length of the header, etc. While the exact data found within a header packet can vary depending on the type of communication protocol being used, the principles as related to the system disclosed herein to any communication protocol which utilizes header packets to direct information.

Once a header packet is identified, the system selects key data within the header. While the key data can vary depending on configuration, in this example the key data identified by the system includes the source, the destination, and length/amount of data in the packet accompanying the header packet (i.e., the data packet). The system captures that key data from the header packet, then performs a hash function on the key data, resulting in a hash (also referred to as a Universally Unique Identifier (UUID)). Each Hash/UUID collects information that is readily available within a packet header to create a single database (DB) entry for that UUID. In other words, a hash of the packet header data can have additional data added to it, resulting in a UUID DB entry. Once the system has generated the UUID DB entry, the UUID DB entry can then be populated with additional data, context, etc. associated with the data going through the router (e.g., metadata). For example, if the UUID DB entry is based on the source and destination ports, additional data can be added to describe the length of the data, a maximum number of permitted nodes/transfers allowed for the data, etc. Further non-limiting examples of additional data that can be stored in the UUID DB and compared against UUID DB entries can include: type of traffic (gaming, Content Delivery Network (CDN), web, real-time video, etc.), traffic details (the application name), traffic priority/QoS, and/or reputation score. For example, one might see in the UUID DB a list types of traffic as follows:

1. CDN – WORLD OF WARCRAFT Download Traffic - low priority

2. Real-time – WORLD OF WARCRAFT Game Data - high priority

3. Real-time – ZOOM Meeting - high priority

4. CDN – NETFLIX - medium priority

5. Web Traffic - medium priority

6. Unknown - low priority

The system, after generating the UUID DB entry then sends the resulting hash/UUID to a cloud database, which compares the hash to previously recorded hashes. While different configurations are possible, in a simple example the hash/UUID (not the additional information added to the hash) could represent a packet’s destination IP, port, and protocol. In such configurations, the Hash/UUID will always be the same as previously generated hashes/UUIDs if these data points are identical to those previous instances (i.e., are the same destination IP, port, and protocol). In other configurations, there may be a separate hashes/UUIDs to represent source IPs, reputation, and fingerprint information about the transmitting and/or receiving device. For example, there may be an individual hash/UUID for the source, another hash/UUID for the destination, yet another hash/UUID for the amount of data, and/or other desired information about the packet. Those individual hashes/UUIDs can then be combined together to form a hash/UUID that is forwarded to the cloud DB. Based on that comparison, the cloud DB returns priority instructions to the system indicating the priority which should be given to the data. The system then forwards those priority instructions to the router, and the router routes the data accordingly. Because the processing is done in the cloud, not on the router, the router resources are not used. Once the cloud system has compared the hash/UUID to previously recorded hashes (thereby identifying the ports, type of data, etc. being communicated), the cloud system can establish the priority of the data and the cloud system can inform the router regarding this priority for better processing for future packets. In this manner, the improvements disclosed herein improve traffic management for congested network systems.

In some configurations, the priority instructions provided from the system to the router may be a ranking, where an alphanumerical value is assigned to the data (e.g., priority 10 data has higher priority than priority 6 data which has higher priority than priority 2 data; or priority A data has higher priority than priority C data). Based on these rankings, the system (as communicated to the router) can route the data to servers, switches, or other networking components. In this manner, the system provides context so that other devices (or, in some configurations, system administrators) can decide how to manage the data. In other configurations, the priority instructions can identify to which servers, switches, or other networking components the data should be transmitted to, and the system can follow the priority instructions by processing the data accordingly.

Because the instructions and analysis of the packet header are performed in the cloud (i.e., via serverless computation, where the computational resources can be allocated on an as-used basis) the complexity/computational resources required on the router are reduced. Using the disclosed system the computing required is less than doing the same computations using local processing. More specifically, every router tied (e.g., communicatively networked) into the system has access to the same shared knowledge. For example, upon receiving a hash/UUID at the cloud DB, the system determines if that same hash/UUID has been previously received. If it has, the same priority that was previously identified can be used again. If the hash/UUID is new, the system can classify the traffic based on the hash/UUID, identifying from the hash/UUID (and/or the additional data appended to the hash/UUID as an additional entry) the source/destination ports, the type of traffic, the size of the packets, etc. of the data. Based on those ports, size, etc., the system can identify the type and/or priority of the data, and can use that priority classification for future instances when the same hash/UUID is received and recognized. Once the priority/classification is determined, this information is shared with all connected devices and does not need to be processed again unless a change (e.g., a new port, a new address, etc.) is detected. In addition, it reduces the need to constantly update the router’s memory when new IP addresses are used for new games/services. For example, if a user begins playing a game which sends/receives data, traditionally the user’s home router would not know how to prioritize the data without specific instructions/updates. However, using the disclosed system, the cloud DB is updated when new IP addresses associated with new games/services are identified. For example, the creators of a game may publish their IP addresses so data can be accurately prioritized to those IP addresses. In such circumstances, the disclosed system receives the data associated with the game, pulls key information from a header packet within the data, and identifies a new IP address. That new IP address is hashed and the resulting hash sent to the cloud DB. Because the cloud DB has already been updated to include the IP addresses for the new game, the cloud DB returns priority instructions based on the type of data (in this example a game) and/or other factors (such as the physical location of the game’s IP addresses), and the system sends those priority instructions (or a portion thereof) to the router. Major priority instructions could include:

1. Real-time communications (high priority)

2. Cacheable content (low priority, it can be buffered)

3. High bandwidth content (low priority)

4. Unknown/suspicious traffic (low priority)

Likewise, in situations where anomalous/suspicious data is identified (e.g., based on sending/receiving information to/from unknown IP addresses, the particular types of data, size of data packets, overall bandwidth, etc.) by the cloud DB after receiving header data from a first router, that anomalous/suspicious data can be flagged for further review. When the investigation is complete, the results can be saved in the cloud DB, such that all deployed systems immediately have access to the results of the investigation (rather than the results needing to be communicated to each individual router/system).

In some configurations, the system can use Artificial Intelligence (AI) (either on the router or in the cloud DB during analysis of hashed data) to better identify unfamiliar traffic. For example, the AI can deploy machine learning to record data being received, record the predicted data types and predicted priority of the data, and over time optimize how the unfamiliar traffic is routed. AI can be used to learn traffic patterns based on historical traffic classifications. Based on historical classifications, AI can apply the same classifications identified in historical traffic classifications to future/unknown traffic. In other configurations, an administrator could set a threshold to determine how much trust to give to the new AI traffic classifications (i.e., to immediately accept the new classifications or to have an administrator review the AI classifications before being used on actual data).

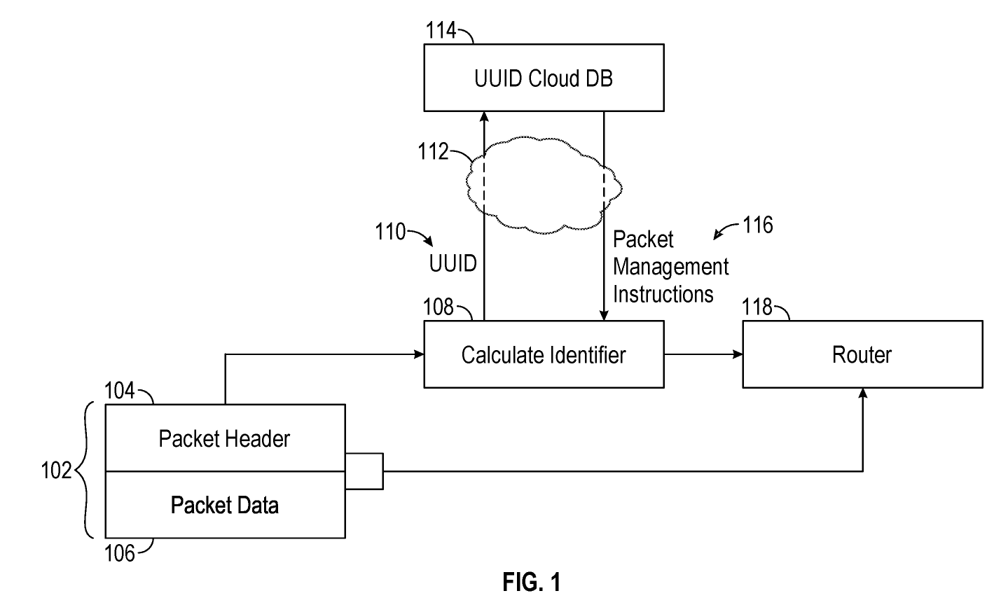

FIG. 1 illustrates a first example system obtaining packet management instructions from a cloud-based database. As illustrated, the system receives data 102, the data 102 including a packet header 104 and packet data 106. The system uses the packet header 104 to calculate a unique identifier 108, resulting in a Universally Unique Identifier (UUID) 110. Preferably, the UUID 110 is a hash of one or more pieces of data within the packet header 104. The system transmits the UUID 110 across a network 112 (such as, but not limited to, the Internet) to a UUID cloud-based database (DB) 114. The UUID cloud-based DB 114 analyzes the UUID 110, comparing the UUID 110 against previously stored identifiers, and based on that comparison generates packet management instructions 116 (aka priority instructions) for the data 102. The UUID cloud-based DB 114 transmits these packet management instructions 116 back to the system (i.e., across the network 112). The system then forwards the packet management instructions 116 and the data 102 to a router 118 for routing the data 102 to its destination using servers, routers, switches, and other network equipment as dictated by the packet management instructions 116.

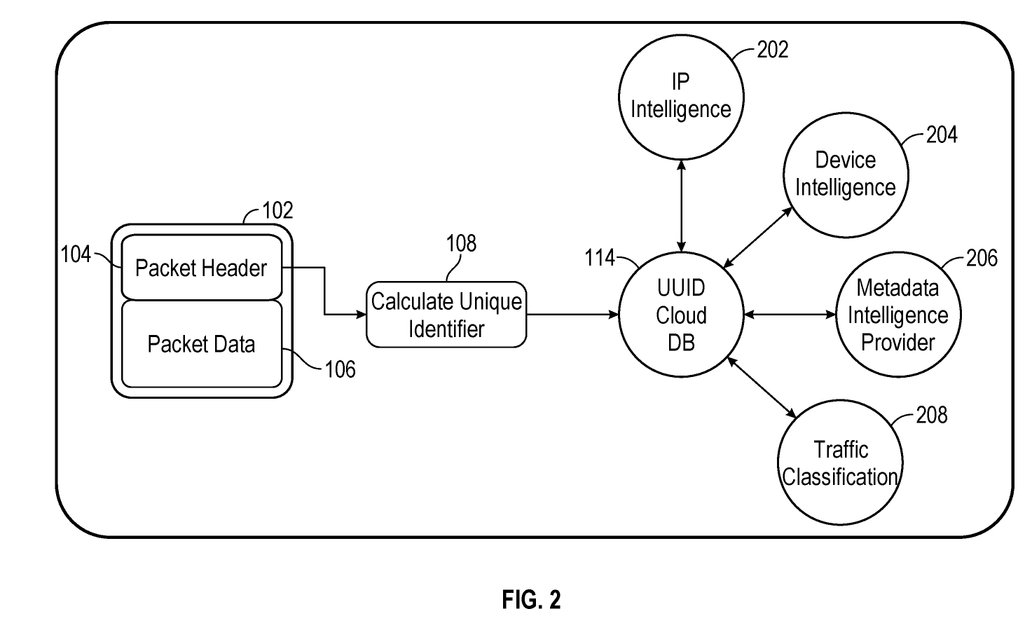

FIG. 2 illustrates a second example system of obtaining packet management instructions from a cloud-based database. In this example, the system again receives data 102 containing a packet header 104 and packet data 106. The system uses the packet header 104 to calculate the unique identifier 108, and sends the UUID to the UUID cloud-based DB 114. However, this example further illustrates the type of analysis the UUID cloud-based DB 114 can perform to identify the priority and packet management instructions 116 which will be forwarded to the router 118 in FIG. 1. As illustrated here, such priority can be based on the IP intelligence 202 (such as the source and destination IP addresses of the data 106, as identified in the packet header 104); the device intelligence 204 (e.g., the type of device from which the data 102 is being received, or to which the data 102 is being transmitted); metadata intelligence provider 206 (such as size, date, time of day, or other factors which may be stored describing the packet data 106); and/or traffic classification 208 (for example, if the type of data is already known based on the size, source, destination, or other factors).

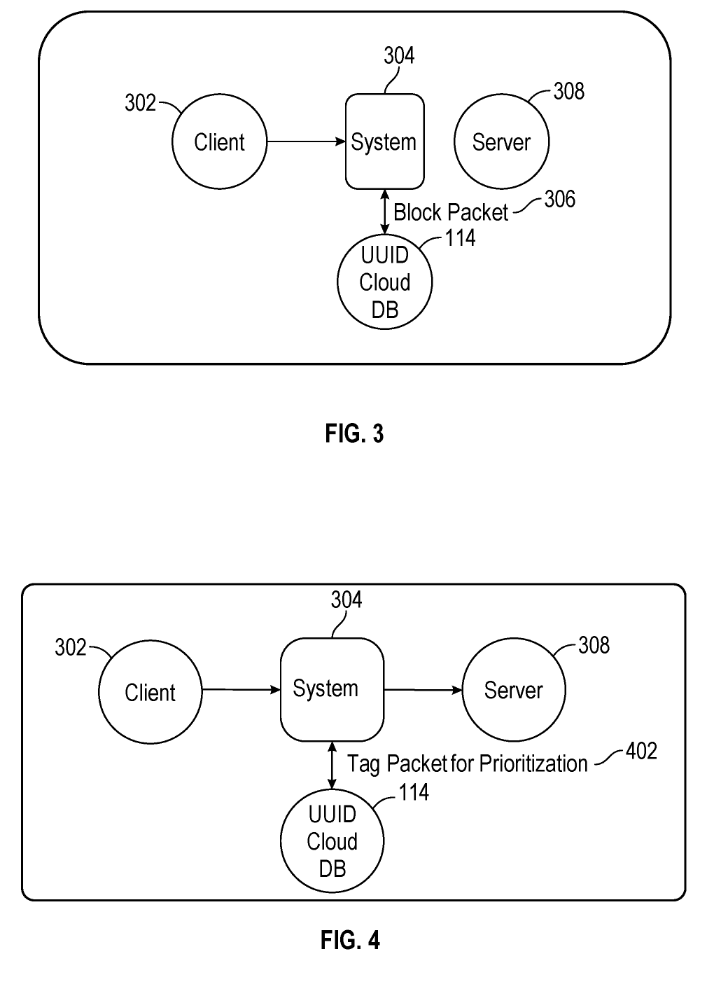

FIG. 3 illustrates an example of the system 304 (acting as a firewall) blocking packets from a client 302 to a server 308 based on information from the UUID cloud-based DB 114. As illustrated, the UUID cloud-based DB 114 analyzes information received from the system 304 about a packet of data, then the UUID cloud-based DB 114 sends a signal to the system 304 to block the packet 306 from being sent to the server 308. For example, the UUID cloud-based DB 114 may have detected that the destination address is associated with illegal activity. For example, the most likely reason that traffic could be blocked is because Distributed Denial-of-Service (DDOS)/botnet traffic is detected. Systems configured as disclosed herein proactively reduce DDOS/botnet traffic that is originating from a compromised device on the LAN.

FIG. 4 illustrates an example of the system 304 (acting as a gateway) forwarding packets from a client 302 to a server 308 based on information from the UUID cloud-based DB 114. In this example, the UUID cloud-based DB 114 has determined that the UUID provided by the system 304 indicates that the associated packet data should be forwarded to the server 308, and has tagged the packet for prioritization 402 the tag packet for prioritization 402 providing priority instructions regarding how the packet data should be routed/prioritized enroute to the server 308.

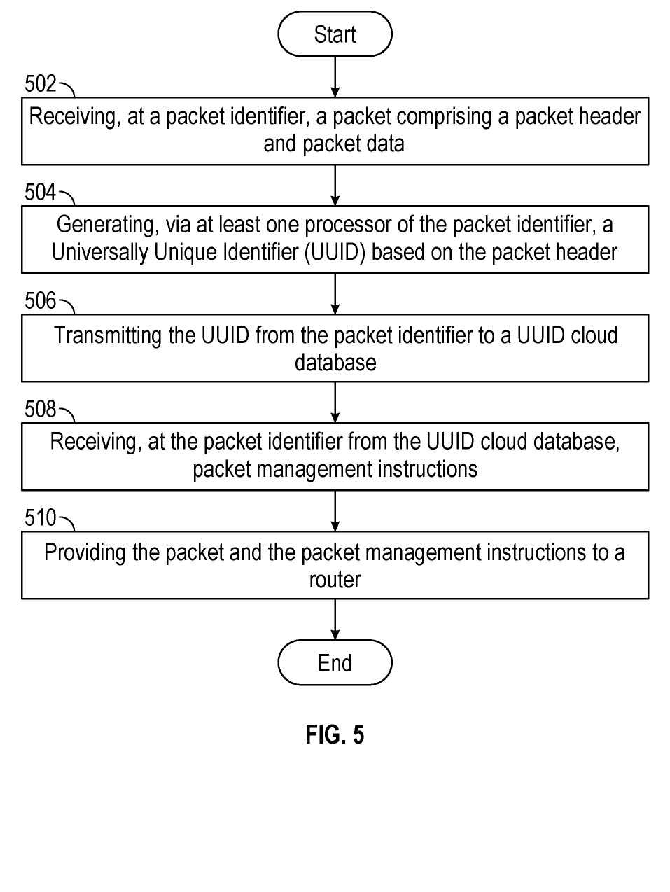

FIG. 5 illustrates an example method embodiment. As illustrated, a method can include receiving, at a packet identifier, a packet comprising a packet header and packet data (502). The packet identifier (or system) can then generate, via at least one processor of the packet identifier, a Universally Unique Identifier (UUID) based on the packet header (504), and transmit the UUID from the packet identifier to a UUID cloud database (506). The packet identifier can then receive, from the UUID cloud database, packet management instructions (508) (also referred to as priority instructions), and provide the packet and the packet management instructions to a router (510).

In some configurations the packet management instructions are further based on a device type of a device containing the packet identifier.

In some configurations, the UUID cloud database can identify a source Internet Protocol (IP) address and a destination IP address mismatch.

In some configurations, the illustrated method can further include: transmitting, from the packet identifier to the UUID cloud database, a device fingerprint of the packet identifier.

In some configurations, when the UUID is not found in the UUID cloud database, the packet management instructions can cause the packet to be at least one of de-prioritized or flagged for review.

In some configurations, the UUID cloud database identifies a type of traffic to which the packet belongs. In such configurations, the type of traffic can include one or more of: gaming traffic; video streaming traffic; work from home traffic; and/or web browser traffic.

Systems configured herein can be configured to forward information as desired into the packet classification database (which is in the cloud). This information can also include Content Delivery Network (CDN) traffic, Internet Of Things (IOT) traffic, torrent traffic, botnet traffic, etc. Such examples are not limiting, and the information which can be sent to the cloud DB can include any data desired by a system user (e.g., a network administrator).

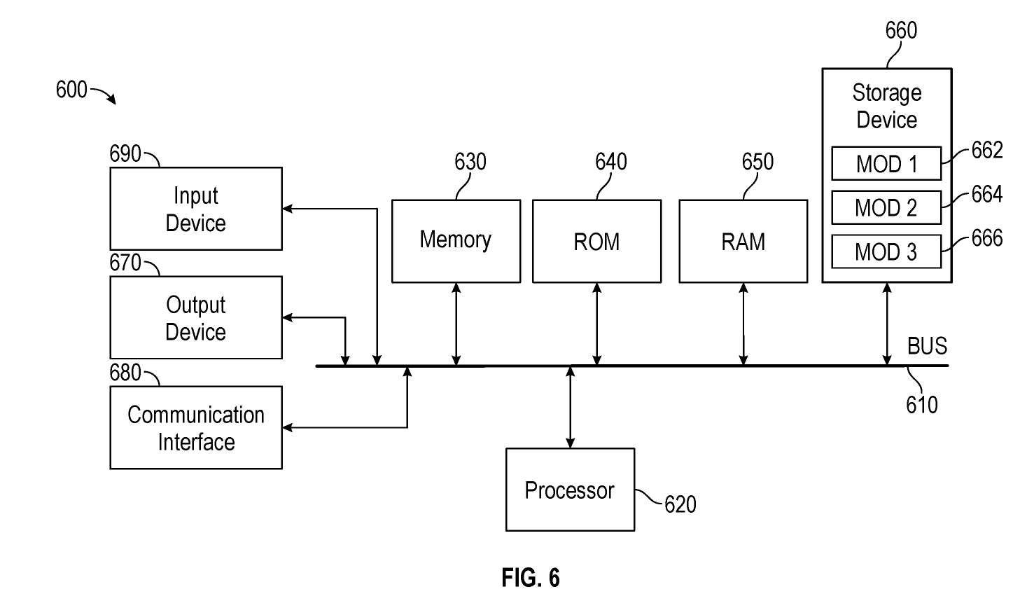

With reference to FIG. 6, an exemplary system includes a computing device 600 (such as a general-purpose computing device), including a processing unit (CPU or processor) 620 and a system bus 610 that couples various system components including the system memory 630 such as read-only memory (ROM) 640 and random access memory (RAM) 650 to the processor 620. The computing device 600 can include a cache of high-speed memory connected directly with, in close proximity to, or integrated as part of the processor 620. The computing device 600 copies data from the system memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The system memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1662, module 2664, and module 3666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in memory ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, system bus 610, output device 670 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 600 is a small, handheld computing device, a desktop computer, or a computer server.

Although the exemplary embodiment described herein employs the storage device 660 (such as a hard disk), other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a packet identifier, a packet comprising a packet header and packet data; generating, via at least one processor of the packet identifier, a Universally Unique Identifier (UUID) based on the packet header; transmitting the UUID from the packet identifier to a UUID cloud database; receiving, at the packet identifier from the UUID cloud database, packet management instructions; and providing the packet and the packet management instructions to a router.

The method of any preceding clause, wherein the packet management instructions are further based on a device type of a device containing the packet identifier.

The method of any preceding clause, wherein the UUID cloud database identifies a source Internet Protocol (IP) address and a destination IP address mismatch.

The method of any preceding clause, further comprising: transmitting, from the packet identifier to the UUID cloud database, a device fingerprint of the packet identifier.

The method of any preceding clause, wherein: when the UUID is not found in the UUID cloud database, the packet management instructions cause the packet to be at least one of de-prioritized or flagged for review.

The method of any preceding clause, wherein: the UUID cloud database identifies a type of traffic to which the packet belongs.

The method of any preceding clause, wherein the type of traffic comprises one or more of: real-time communications traffic; video streaming traffic; work from home traffic; Content Delivery Network (CDN) traffic; Internet Of Things (IOT) traffic; torrent traffic; malicious or suspicious traffic; or web browser traffic.

A system comprising: at least one processor; and a non-transitory computer-readable storage medium having instructions stored which, when executed by the at least one processor, cause the at least one processor to perform operations comprising: receiving a packet comprising a packet header and packet data; generating a Universally Unique Identifier (UUID) based on the packet header; transmitting the UUID to a UUID cloud database; receiving, from the UUID cloud database, packet management instructions; and providing the packet and the packet management instructions to a router.

The system of any preceding clause, wherein the packet management instructions are further based on a device type of a device containing the system.

The system of any preceding clause, wherein the UUID cloud database identifies a source Internet Protocol (IP) address and a destination IP address mismatch.

The system of any preceding clause, the non-transitory computer-readable storage medium having additional instructions stored which, when executed by the at least one processor, cause the at least one processor to perform operations comprising: transmitting, from the system to the UUID cloud database, a device fingerprint of the system.

The system of any preceding clause, wherein: when the UUID is not found in the UUID cloud database, the packet management instructions cause the packet to be at least one of de-prioritized or flagged for review.

The system of any preceding clause, wherein: the UUID cloud database identifies a type of traffic to which the packet belongs.

The system of any preceding clause, wherein the type of traffic comprises one of: real-time communications traffic; video streaming traffic; work from home traffic; CDN traffic; IOT traffic; torrent traffic; malicious or suspicious traffic; or web browser traffic.

A non-transitory computer-readable storage medium having instructions stored which, when executed by at least one processor, cause the at least one processor to perform operations comprising: receiving, at a packet identifier, a packet comprising a packet header and packet data; generating a Universally Unique Identifier (UUID) based on the packet header; transmitting the UUID to a UUID cloud database; receiving, from the UUID cloud database, packet management instructions; and providing the packet and the packet management instructions to a router.

The non-transitory computer-readable storage medium of any preceding clause, wherein the packet management instructions are further based on a device type of a device containing the packet identifier.

The non-transitory computer-readable storage medium of any preceding clause, wherein the UUID cloud database identifies a source Internet Protocol (IP) address and a destination IP address mismatch.

The non-transitory computer-readable storage medium of any preceding clause, having additional instructions stored which, when executed by the at least one processor, cause the at least one processor to perform operations comprising: transmitting, from the packet identifier to the UUID cloud database, a device fingerprint of the packet identifier.

The non-transitory computer-readable storage medium of any preceding clause, wherein: when the UUID is not found in the UUID cloud database, the packet management instructions cause the packet to be at least one of de-prioritized or flagged for review.

The non-transitory computer-readable storage medium of any preceding clause, wherein: the UUID cloud database identifies a type of traffic to which the packet belongs.

We claim:

1. A method comprising:
receiving, at a packet identifier, a packet comprising a packet header and packet data;
generating, via at least one processor of the packet identifier, a Universally Unique Identifier (UUID) based on the packet header;
transmitting the UUID from the packet identifier to a UUID cloud database;
receiving, at the packet identifier from the UUID cloud database, packet management instructions; and
providing the packet and the packet management instructions to a router.

2. The method of claim 1, wherein the packet management instructions are further based on a device type of a device containing the packet identifier.

3. The method of claim 1, wherein the UUID cloud database identifies a source Internet Protocol (IP) address and a destination IP address mismatch.

4. The method of claim 1, further comprising:
transmitting, from the packet identifier to the UUID cloud database, a device fingerprint of the packet identifier.

5. The method of claim 1, wherein:
when the UUID is not found in the UUID cloud database, the packet management instructions cause the packet to be at least one of de-prioritized or flagged for review.

6. The method of claim 1, wherein:
the UUID cloud database identifies a type of traffic to which the packet belongs.

7. The method of claim 6, wherein the type of traffic comprises one of:
real-time communications traffic;
video streaming traffic;
work from home traffic;
Content Delivery Network (CDN) traffic;
Internet Of Things (IOT) traffic;
torrent traffic;
malicious or suspicious traffic; or
web browser traffic.

8. A system comprising:
at least one processor; and
a non-transitory computer-readable storage medium having instructions stored which, when executed by the at least one processor, cause the at least one processor to perform operations comprising:
receiving a packet comprising a packet header and packet data;
generating a Universally Unique Identifier (UUID) based on the packet header;
transmitting the UUID to a UUID cloud database;
receiving, from the UUID cloud database, packet management instructions; and
providing the packet and the packet management instructions to a router.

9. The system of claim 8, wherein the packet management instructions are further based on a device type of a device containing the system.

10. The system of claim 8, wherein the UUID cloud database identifies a source Internet Protocol (IP) address and a destination IP address mismatch.

11. The system of claim 8, the non-transitory computer-readable storage medium having additional instructions stored which, when executed by the at least one processor, cause the at least one processor to perform operations comprising:
transmitting, from the system to the UUID cloud database, a device fingerprint of the system.

12. The system of claim 8, wherein:
when the UUID is not found in the UUID cloud database, the packet management instructions cause the packet to be at least one of de-prioritized or flagged for review.

13. The system of claim 8, wherein:
the UUID cloud database identifies a type of traffic to which the packet belongs.

14. The system of claim 13, wherein the type of traffic comprises one of:
real-time communications traffic;
video streaming traffic;
work from home traffic;
CDN traffic;
IOT traffic;
torrent traffic;
malicious or suspicious traffic; or
web browser traffic.

15. A non-transitory computer-readable storage medium having instructions stored which, when executed by at least one processor, cause the at least one processor to perform operations comprising:
receiving, at a packet identifier, a packet comprising a packet header and packet data;
generating a Universally Unique Identifier (UUID) based on the packet header;
transmitting the UUID to a UUID cloud database;
receiving, from the UUID cloud database, packet management instructions; and
providing the packet and the packet management instructions to a router.

16. The non-transitory computer-readable storage medium ofclaim 15, wherein the packet management instructions are further based on a device type of a device containing the packet identifier.

17. The non-transitory computer-readable storage medium ofclaim 15, wherein the UUID cloud database identifies a source Internet Protocol (IP) address and a destination IP address mismatch.

18. The non-transitory computer-readable storage medium of claim 15, having additional instructions stored which, when executed by the at least one processor, cause the at least one processor to perform operations comprising:
transmitting, from the packet identifier to the UUID cloud database, a device fingerprint of the packet identifier.

19. The non-transitory computer-readable storage medium ofclaim 15, wherein:
when the UUID is not found in the UUID cloud database, the packet management instructions cause the packet to be at least one of de-prioritized or flagged for review.

20. The non-transitory computer-readable storage medium ofclaim 15, wherein:
the UUID cloud database identifies a type of traffic to which the packet belongs.
